(19) United States
(12) Patent Application Publication
(10) Pub. No.: US 2004/0143684 A1
(43) Pub. Date: Jul. 22, 2004

(54) State-displaying device

(76) Inventor: Kang-Chung Cheng, Taipei (TW)

Correspondence Address: Han-Yi Lee, BAYSHORE PATENT GROUP, LLC., 520 Chantecler Dr., Fremont, CA, 94539, US

(21) Appl. No.: 10/677,048

(22) Filed: Sep. 30, 2003

(30) Foreign Application Priority Data
Jan. 20, 2003 (TW) 092201005

(51) Int. Cl. G06F 3/00

(52) U.S. Cl. 710/1

(57) ABSTRACT

The state-displaying device is used for displaying the state data of a data-processing device, it includes a universal asynchronous receiver/transmitter (UART) interface and a displaying device. The universal asynchronous receiver/transmitter interface can output the state data received in a serial mode to the displaying device. When the displaying device receives the state data, a microprocessor can be used to generate a displaying signal in corresponding to the state data, and the displaying signal is fed into a multi-segment display module to render it to display a symbol in corresponding to the state of the system.

### FIELD OF THE INVENTION

The present invention is related to a state-displaying device, and especially to a digital device for displaying the state of a computer system.

### BACKGROUND OF THE INVENTION

By prosperous development of the computer industry, hardware equipments have been well developed; to satisfy the requirements of debugging of hardware engineers, debug cards have been developed too. Presently, debug cards are mostly applied on personal computers and are coupled to the PCI buses or ISA buses of mainframes, the system states are displayed by numbers of lamp or numerals. By the fact that the definition of connecting pins of buses is complicated, the measures of displaying stated will increase complexity of performance of a debug card, this is because that the debug card occupies a bus slot, and this makes scarifying of expansion of a computer system and is quite unworthy. With this reason, manufacturers of main boards presently build debug cards directly in main boards; although this can reduce a slot in use, this cannot solve other problems.

For example, by the fact that a debug card is connected to a main board, while the main board is enclosed by the housing of a computer, so that when operation of the system is abnormal, it is necessary to dismantle the hosing to examine the wrong messages displayed on the debug card, this is very inconvenient. In addition to this, most debug cards built in main boards can only detect the abnormal states in a power-on self test (POST), and can do nothing for detecting after power on. Application of the computer network has been very popularized since a long time ago, stability of systems is highly asked for, if operation of a system is out of work, a debug card unable to display the system state is evidently unable to satisfy the actual requirement. Even if a debug card able to detect the system state has been adopted, the wrong message can only be seen when the housing is dismantled. Taking the adventure of dismantling the housing on a server unable of turning off may induce larger damage to the hardware.

### SUMMARY OF THE INVENTION

The primary object of the present invention is to provide a state-displaying device able to connect externally to a connecting port of a computer for monitoring.

Another object of the present invention is to provide a state-displaying device to display wrong messages during power on.

According to the objects of the present invention, the state-displaying device is provided; the device is described summarily as below:

The state-displaying device is used to display the state data of a data-processing device; such a data-processing device for instance can be a server or a personal computer. The state-displaying device includes a universal asynchronous receiver/transmitter (UART) interface and a displaying device; the universal asynchronous receiver/transmitter interface can output the state data received in a serial mode. When the displaying device receives the state data from the universal asynchronous receiver/transmitter interface, a microprocessor can be used to generate a displaying signal in corresponding to the state data, and the displaying signal is fed into a multi-segment display module to display a symbol in corresponding to the state data for distinguishing of a user.

The present invention will be apparent in its objects, features and advantages after reading the detailed description of the preferred embodiment thereof in reference to the accompanying drawings.

### BRIEF DESCRIPTION OF THE DRAWINGS

FIG. 1 is a block diagram of a state-displaying device of a preferred embodiment of the present invention;

FIG. 2A is a schematic view showing a multi-segment display module composed of three seven-segment displays;

FIG. 2B is a schematic view showing the multi-segment display module in displaying English letters;

FIG. 2C is a schematic view showing the multi-segment display module in displaying numerals;

FIG. 2D is a schematic view showing the multi-segment display module in displaying specific characters;

FIG. 3 is a schematic view showing the present invention is connected with a data-processing device;

FIG. 4 is a table showing an example of the present invention displaying state data;

FIG. 5 is a table showing the data structure of the state data in the embodiment of the present invention; and

FIG. 6 is a table showing the relationship between the displaying bits and the corresponding results displayed which are obtained in the mode of searching.

### DETAILED DESCRIPTION OF THE INVENTION

The idea of the present invention is to modularize the electric circuits of debug cards which each is connected to an already given connecting port on a data-processing device 200 to get an object of monitoring the system state without dismantling a housing. The data-processing device 200 for instance can be a server or a personal computer. As is well known, a computer will be equipped with a connecting port suiting multiple specifications, wherein a serial port not only is easier for practicing by that its data form is less complicated, but also its chance of utilizing is larger (Normal computers mostly each is provided with two serial ports, one is used for a modem, the other is normally left unused, the unused serial port can be used for a debug card. If the computer uses a network card for line connection, the two serial ports both can be used, this is more flexible in use.) In view of this, the followings give description for a state-displaying device 100 able to connect externally to a serial port.

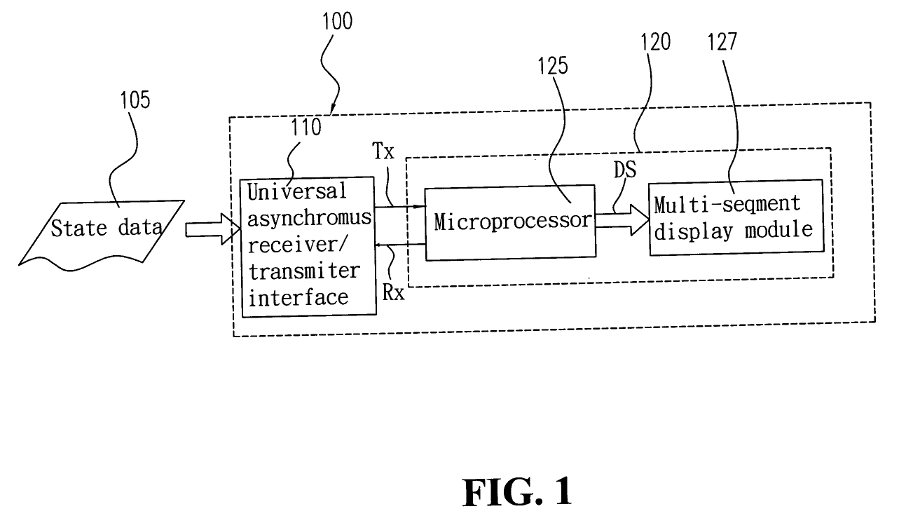

Referring to FIG. 1 being a block diagram of a state-displaying device 100 of a preferred embodiment of the present invention, the state-displaying device 100 includes a universal asynchronous receiver/transmitter interface 110 and a displaying device 120, the displaying device 120 includes a microprocessor 125 and a multi-segment display module 127. Wherein the microprocessor 125 for instance can be a microprocessor chip with serial number of 8051. State data 105 are used to respond to the state of the data-processing device 200 during a power-on self test (POST) or when being entering the operating system; when the universal asynchronous receiver/transmitter interface 110 receives the state data 105, it converts the data into a serial mode for outputting to be displayed on the displaying device 120. By virtue that the universal asynchronous receiver/transmitter interface 110 outputs the state data 105 in the serial mode, so that the line connection between the universal asynchronous receiver/transmitter interface 110 and the displaying device 120 is very simple. Taking the specification of RS-232 as an example, the present invention is not necessary to use the control signals including the asynchronous data transmitting rate (Baud rate), flow control (XON/XOFF, RTS/CTS) of the specification of RS-232 etc., it needs only a data transmitting line Tx, a data receiving line Rx, a power line and a grounding line (Gnd) to complete the work of transmitting the state data 105. If the state-displaying device 100 itself does not need to transmit back the data to the universal asynchronous receiver/transmitter interface 110, and even only the three lines including the data transmitting line Tx, the power line and the grounding line (Gnd) are needed to get the normal operation, thereby, the number of lines for connection can be lowered to the minimum, and the structure can be quite simplified.

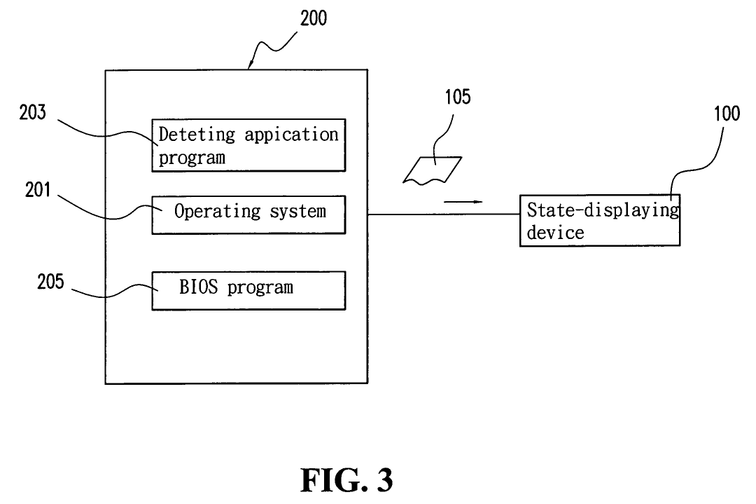

Referring to FIG. 3 which is a schematic view showing that the present invention is connected with a data-processing device, the state data 105 of the present invention mainly is generated from the data-processing device 200 through an executive program, for example, the data-processing device 200 can use an operating system 201 to detect the state through execution of a detecting application program 203 and at the same time to generate the state data 105, or can use a BIOS program 205 to detect and generate the state data 105, then the state data 105 is displayed through the present invention to render a user to see the situation of operation of the data-processing device 200. The general practicing way is to make the BIOS program 205 to detect the state and generate the state data 105 during power on of the data-processing device 200; and after the operating system 201 is turned on, the operating system 201 detects the state through the detecting application program 203 and at the same time generates the state data 105. When the microprocessor 125 receives the state data 105, it can output a displaying signal DS in corresponding to the state data to the multi-segment display module 127 to make it display a symbol in corresponding to the state data 105, the symbol for instance can be a numeral, an English letter or a specific character.

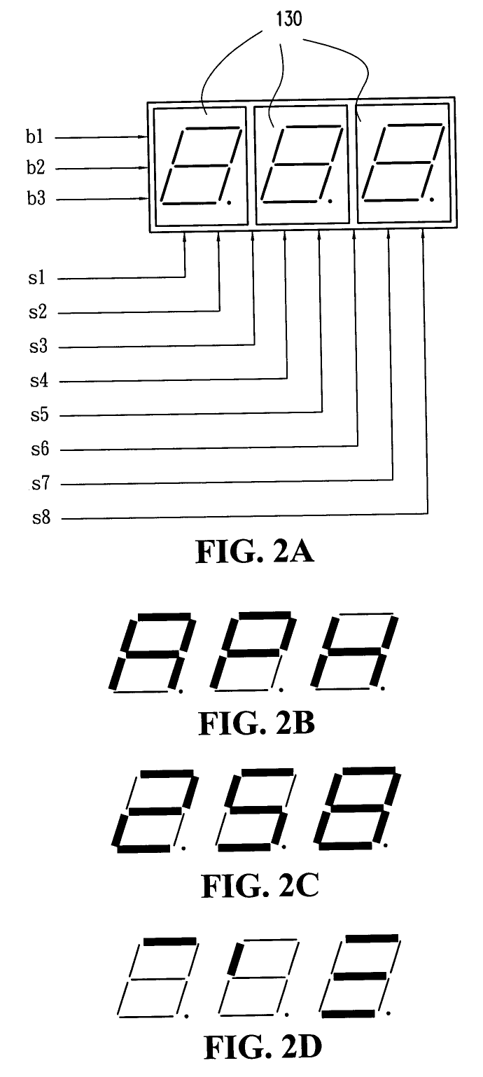

In practicing, the multi-segment display module 127 can use at least a seven-segment display, referring to FIG. 2A, wherein a multi-segment display module composed of three seven-segment displays is depicted. The multi-segment display module 127 includes three seven-segment displays 130 to display a corresponding symbol according to the displaying signal DS from the microprocessor 125. Each seven-segment display is composed of seven LED's arranged to form “8” and a round point at the lower right corner thereof; generally, the eight signals are used to respectively control power on/off of the LED's. That is to say, the displaying signal DS can include bit selection signals b1, b2, b3 and segment selection signals s1, s2, s3, s4, s5, s6, s7 and s8; wherein the bit selection signals b1, b2, b3 can be used to designate an “enable” from the three seven-segment displays 130 (the other two not designated are called disables), the segment selection signals s1, s2, s3, s4, s5, s6, s7 and s8 are used to designate the power on or off states of the “enable” of the three seven-segment displays 130 to display a symbol in corresponding to the state data 105. In application, the three seven-segment displays 130 function continuously and alternately; so long that the frequency of switching is fast enough, the phenomenon of persistence vision will render the user to see results together shown by the three seven-segment displays 130 without having the sequence of power on/off of the three seven-segment displays 130 become aware of. For example, FIG. 2B shows the multi-segment display module in displaying English letters APH, FIG. 2C shows the module in displaying the numeral 258, while FIG. 2D shows the module in displaying the characters with some specific meaning; so that the user can be aware of the system state indicated by the symbol presented by the multi-segment display module 127 through a mode of searching. By all means, the multi-segment display module 127 can also present a combination of English letters and numerals, such as A07, P12 etc. this is very flexible.

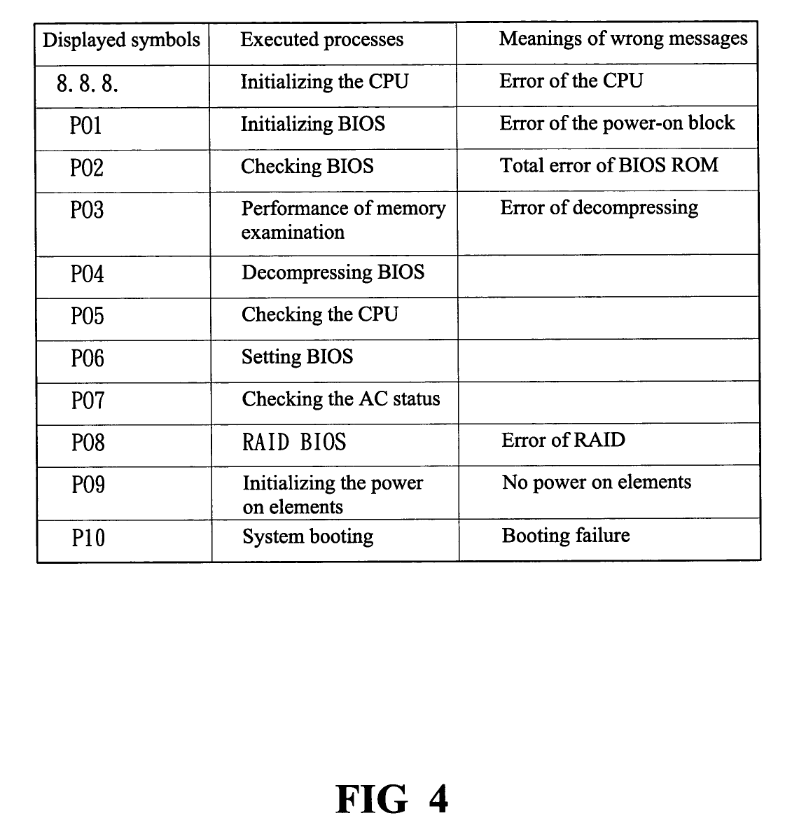

The paragraph hereinafter describes by examples the meaning of the symbol displayed on the multi-segment display module 127, referring to FIG. 4 which is an example showing the present invention displaying the state data, the first column in FIG. 4 lists the symbols displayed on the multi-segment display module 127; the second column lists the processes executed then; the third column lists the meanings represented by the wrong messages. When the data-processing device 200 initializes the CPU, the multi-segment display module 127 displays “8.8.8.”. If initialization of the CPU is completed, the initialization process of the next BIOS program 205 is performed, then the multi-segment display module 127 displays P01 in executing this process. If the initialization process of the BIOS program 205 fails, the P01 displayed by the multi-segment display module 127 flashes; now, the user can be aware of that a problem happens to the initialization process of the BIOS program 205.

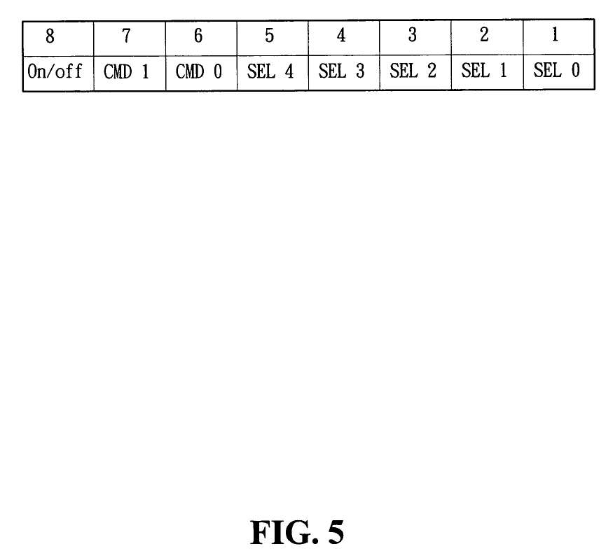

On the other hand, the main function of the microprocessor 125 is to convert the state data 105 fed in by the universal asynchronous receiver/transmitter interface 110 into a displaying signal DS to make the multi-segment display module 127 to display a numeral or symbol in corresponding to the state data 105 for distinguishing of the user. FIG. 5 shows the data structure of the state data 105 in the embodiment of the present invention. The definitions of the bits in the state data 105 are decided in pursuance of different command modes; according to different modes of lightening the multi-segment display module 127, two kinds of definitions of the bits as of the searching mode and the following-the-sequence mode can be established in designing to increase the flexibility of practicing. The state data 105 can divide the eight bits into three parts according to different functions of the bits: one is the related on/off bit of the bit 8 used to enable and disable the multi-segment display module 127; the second one is the command mode bit (CMD1, CMD0) composed of the bit 7 and the bit 6 used to select different command modes; the third one are displaying bits composed of the bit 5 and the bit 0 used to lighten the LED in the multi-segment display module 127. When the on/off bit is 1, the multi-segment display module 127 can be activated; and when the on/off bit is 0, the multi-segment display module 127 is turned off. On the other hand, by virtue that the command mode bit (CMD1, CMD0) is composed of two bits, it can have four different combinations that can decide four different command modes; for example, the searching mode (CMD1=0, CMD0=1) and the following-the-sequence mode (CMD1=1, CMD0=0) etc., the following paragraphs will specify the two modes of displaying.

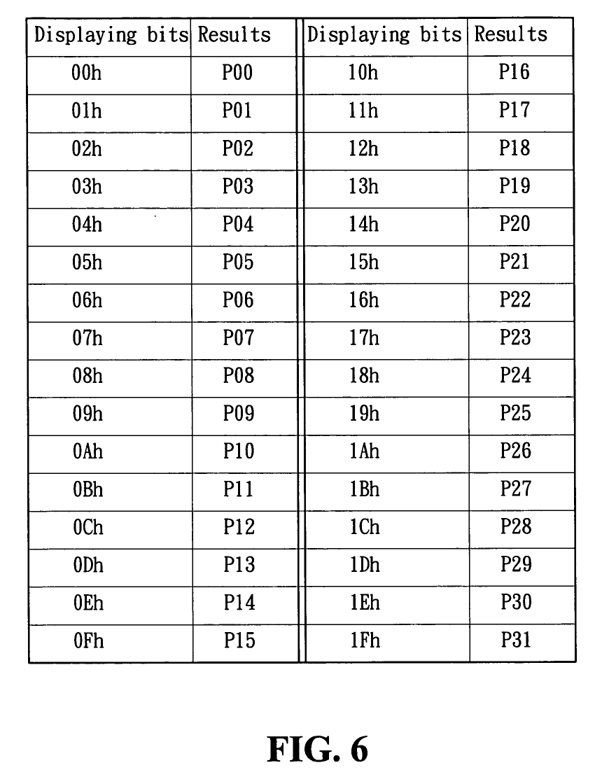

Referring to FIG. 6 which is a table showing the displaying bits and the corresponding results displayed obtained in the mode of searching, when the microprocessor 125 receives the state data 105, it will discriminate the command mode according to the command mode bits CMD1, CMD0 in the state data 105. Thereby when the microprocessor 125 checks out that CMD1=0, CMD0=1, it will make the multi-segment display module 127 to display the state data 105 in the searching mode. The so called searching mode means that a searching is done in a table based on the values of displaying bits to render the multi-segment display module 127 to display the result after searching. The displaying bits are composed of 5 bits, they amounts to 32 different combinations (hexadecimal number system) including 00h to 1Fh etc. When the microprocessor 125 checks out that the value of a displaying bit is 05h, one can search the table at 05h to find the corresponding displaying signal DS to make the multi-segment display module 127 directly lighten the LED's therein to display the symbol of “P05”. Please particularly note that, under the searching mode, the case is that the LED's in the multi-segment display module 127 is lightened once for all to display the symbol (such as P05) rather than that one of the three seven-segment displays 130 is lightened in sequence for displaying (this is the following-the-sequence mode to be described hereinafter). More particularly, when the data-processing device 200 is in execution of checking the CPU, the state data 105 with the value of a displaying bit of 05h are sent out, then the microprocessor 125 searches following 05h, the form of the displaying signal DS required for displaying “P05” by the multi-segment display module 127 can then be searched out, and the displaying signal DS is generated and fed into the multi-segment display module 127. When the multi-segment display module 127 receives the displaying signal DS, it can display the symbol “P05” accordingly and to render the user to be aware of that the data-processing device 200 is in execution of checking the CPU.

When the microprocessor 125 checks out that CMD1=1, CMD0=0, it will make the multi-segment display module 127 to display the state data 105 in the following-the-sequence mode. The so called following-the-sequence mode means that one of the three seven-segment displays 130 is in the first place selected to be enabled, then decision is made that which ones among the LED's of the enabled seven-segment displays are to be lightened to display the corresponding symbol. Under the following-the-sequence mode, the definition of the displaying bits is different from that of the displaying bits of the searching mode, two bits (such as SEL4 and SEL3, hereinafter are called the selecting bits) of the displaying bits are used to designate one of the three seven-segment displays 130 to be enabled, the other three bits (such as SEL2, SEL1 and SEL0, hereinafter are called the segment-selecting bits) are used to lighten some of the LED's of the enabled seven-segment displays. For example, when the multi-segment display module 127 is to display “P05”, it uses firstly the seven-segment display 130 on the left side of the selecting bits for enabling; and uses the segment-selecting bits to make the seven-segment display 130 to display “P”. Then it uses the seven-segment display 130 in the middle of the selecting bits for enabling; and uses the segment-selecting bits to make the seven-segment display 130 to display “0”. Lastly, it uses the seven-segment display 130 on the right side of the selecting bits for enabling; and uses the segment-selecting bits to make the seven-segment display 130 display “5”. It is different from the searching mode in that, the following-the-sequence mode lightens the multi-segment display module 127 directly using the state data 105 in the way to sequentially enable all the seven-segment displays 130 in the multi-segment display module 127 for displaying corresponding symbols; when the multi-segment display module 127 has three seven-segment displays 130, it requires three sets of state data 105 (respectively displayed as P, 0, 5) to make the combination of the symbol “P05” desired to display.

And more, by the fact that the server itself does not have a screen, when it is out of order, maintaining persons always can do nothing. When the present invention is used in the server, it is designed to be connected externally, so that one needs only to check the table using the wrong message presented on the state-displaying device 100, the error can be recognized, and the difficult problem of inability to control the state of a system as is the case before can now be effectively solved. By all means, the present invention can be used on a personal computer without separating from the spirit of it.

In practical application, the present invention can be performed in the way of using the detecting application program 203 after entering into the operating system 201. All the situations of operation of the data-processing device 200 on a platform of the operating system 201, e.g., the network information obtained on line by means of IP data, the number of persons or the state of the network on line, the access state of Raid hard disk etc., are used to generate the state data 105 of the situations of operation using the detecting application program 203; meantime, the time for updating of the state data 105 can be set by one himself, such as updating once every 5 seconds to get the newest state. The present invention can render the user completely not necessary to dismantle a housing or insert a card in knowing the state of a system easily, but necessary only to search on a table according to the numeral displayed on the displaying device, its convenience is largely increased as compared to conventional devices.

The state-displaying device 100 disclosed in the embodiment above of the present invention can be externally connected to a serial port of a server or a personal computer to display a symbol in corresponding to the state of the computer, this is convenient for a user to debug or maintain and repair hardware, and this solves the problem of uneasiness to control the state of a computer existing for long; and particularly, the present invention can be more evident in its effect when it is used on a server. Further, if the state-displaying device 100 itself is provided with an electric power supplying device (such as a battery), only one data transmitting line Tx is required to transmit data in the serial transmitting mode to display the state data 105 of the data-processing device 200. Even if the state-displaying device 100 itself is not provided with an electric power supplying device and is necessary to obtain the required electric power for operation from the computer, only three signal lines are required to perform data transmitting (one positive line, one negative line and one data transmitting line Tx), line connection is very easy.

The preferred embodiment disclosed is only for illustrating the present invention, and not for giving any limitation to the scope of the present invention. It will be apparent to those skilled in this art that various modifications or changes can be made to the present invention without departing from the spirit and scope of this invention. Accordingly, all such modifications and changes also fall within the scope of protection of the appended claims.

What is claimed is:

1. A state-displaying device for displaying state data generated by a data-processing device, said state-displaying device comprises:
a universal asynchronous receiver/transmitter interface for receiving state data for outputting said state data in a serial mode; and
a displaying device including:
a microprocessor coupled to said universal asynchronous receiver/transmitter interface for outputting a displaying signal in corresponding to said state data output by said universal asynchronous receiver/transmitter interface; and
a multi-segment display module coupled to said microprocessor for displaying a symbol in corresponding to said displaying signal.

2. The state-displaying device as in claim 1, wherein said multi-segment display module at least is composed of a seven-segment display.

3. The state-displaying device as in claim 1, wherein said data-processing device is selected between a server and a personal computer.

4. The state-displaying device as in claim 1, wherein said symbol is selected among a numeral, an English letter and a specific character.

5. The state-displaying device as in claim 1, wherein said universal asynchronous receiver/transmitter interface includes a data transmitting line Tx, a data receiving line Rx, a power line and a grounding line (Gnd).

6. The state-displaying device as in claim 1, wherein said state data output by said universal asynchronous receiver/transmitter interface is of a specification of RS-232.

7. The state-displaying device as in claim 1, wherein said state-displaying device is connected externally to a serial port.

8. The state-displaying device as in claim 1, wherein said state data includes an on/off bit, at least a command mode bit and a plurality of displaying bits, said command mode bit is used to define a mode of displaying of said displaying bits, said microprocessor decides a mode of displaying of said multi-segment display module according to said mode of displaying of said displaying bits.

9. The state-displaying device as in claim 8, wherein said command mode bit is used to decide between a searching mode and a following-the-sequence mode.

10. The state-displaying device as in claim 9, wherein when said microprocessor decides that a mode of displaying of said multi-segment display module is said searching mode, it makes said multi-segment display module to display said symbol according to said displaying signal which is generated by searching in a table according to values of said displaying bits.

11. The state-displaying device as in claim 10, wherein said symbol is selected among a numeral, an English letter and a specific character.

12. The state-displaying device as in claim 9, wherein when said microprocessor decides that a mode of displaying is said following-the-sequence mode, a selecting bit of said displaying bits is used to designate a seven-segment display to be enabled, and said enabled seven-segment display is rendered to display said symbol according to the state of a plurality of segment-selecting bits of said displaying bits.

13. The state-displaying device as in claim 12, wherein said symbol is selected among a numeral, an English letter and a specific character.

14. The state-displaying device as in claim 1, wherein said state data is generated by a BIOS program of said data-processing device.

15. The state-displaying device as in claim 1, wherein said state data is generated by a detecting application program of said data-processing device.

16. The state-displaying device as in claim 15, wherein said detecting application program is executed in an operating system of said data-processing device.
